(19) United States
(12) Patent Application Publication
(10) Pub. No.: US 2013/0027275 A1
(43) Pub. Date: Jan. 31, 2013

(54) WIRELESS COMMUNICATION SYSTEM

(71) Applicants: Kazuhiro Odoko, Shizuoka-ken (JP); Hiroki Mochizuki, Shizuoka-ken (JP)

(72) Inventors: Kazuhiro Odoko, Shizuoka-ken (JP); Hiroki Mochizuki, Shizuoka-ken (JP)

(73) Assignee: TOSHIBA TEC KABUSHIKI KAISHA, Tokyo (JP)

(21) Appl. No.: 13/555,521

(22) Filed: Jul. 23, 2012

(30) Foreign Application Priority Data
Jul. 28, 2011 (JP) 2011-165895

(51) Int. Cl. H01Q 1/12

(52) U.S. Cl. 343/882

(57) ABSTRACT

A wireless communication system comprises a tower-shaped antenna including a leaky coaxial cable that leaks electric wave. The tower-shaped antenna is selectively changed from a protruding state in which the antenna is protruded from an installed surface to a housed state in which the antenna is housed in the installed surface, and vice versa.

### CROSS-REFERENCE TO RELATED APPLICATION

This application is based upon and claims the benefit of priority from Japanese Patent Application No. 2011-165895, filed Jul. 28, 2011, the entire contents of which are incorporated herein by reference.

### FIELD

Embodiments described herein relate to a wireless communication system in which a leaky coaxial cable is used as an antenna.

### BACKGROUND

A wireless LAN area can be formed around a leaky coaxial cable by using the leaky coaxial cable, as an antenna. However, in such a case, it is a major element how to arrange and to form the leaky coaxial cable as an antenna to ensure its usability.

### BRIEF DESCRIPTION OF THE DRAWINGS

FIG. 1 is a diagram showing the structure of a first embodiment and a state in which an antenna is protruded;

FIG. 2 is a diagram showing the structure of the first embodiment and a state in which the antenna is housed;

FIG. 3 is a diagram showing the structure of a second embodiment and a state in which an antenna is erected or protruded;

FIG. 4 is a diagram showing the structure of the second embodiment and a state in which the antenna is housed; and

FIG. 5 is a flow chart showing operation process by a controller according to the first and second embodiments.

### DETAILED DESCRIPTION

According to one embodiment, a wireless communication system comprises a tower-shaped antenna including a leaky coaxial cable that leaks electric wave. The tower-shaped antenna is selectively changed from a protruding state in which the antenna is protruded from an installed surface to a housed state in which the antenna is housed in the installed surface, and vice versa.

A first embodiment is described below with reference to the accompanying drawings.

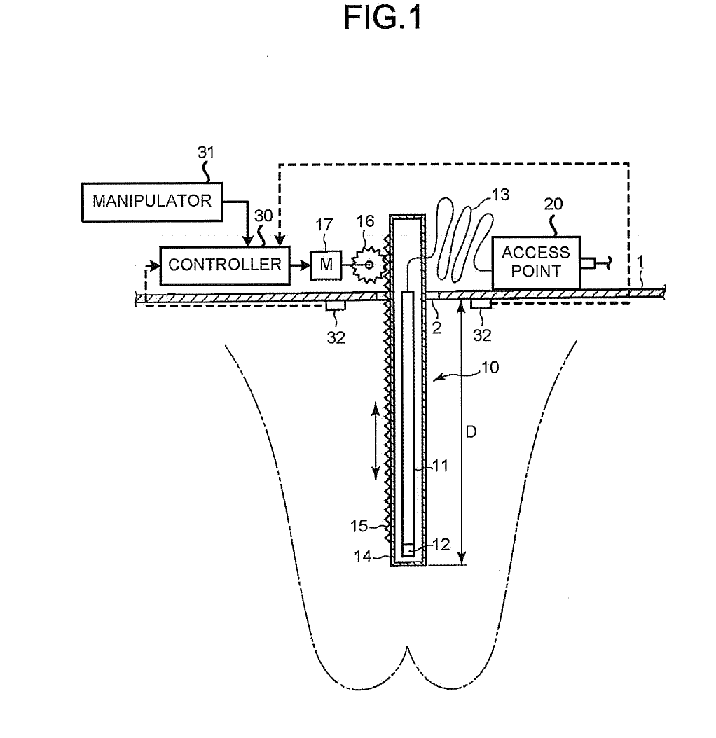

As shown in FIG. 1, a tower-shaped antenna 10 is embedded through the opening 2 of a ceiling surface (installed surface) 1. The antenna 10 includes a leaky coaxial cable 11 which leaks electric wave, a terminator 12 which is arranged at the front end of the leaky coaxial cable 11, a power supplying cable 13 which is led out from the base terminal of the leaky coaxial cable 11, a cylindrical sheath 14 which covers the leaky coaxial cable 11, the terminator 12 and the power supplying cable 13, and a gear unit 15 which is arranged on the outside surface of the sheath 14 along the axis direction of the sheath 14. The leaky coaxial cable 11, which is also referred to as an LCX cable, is formed by arranging a plurality of slots for leaking electric wave along the axis direction thereof.

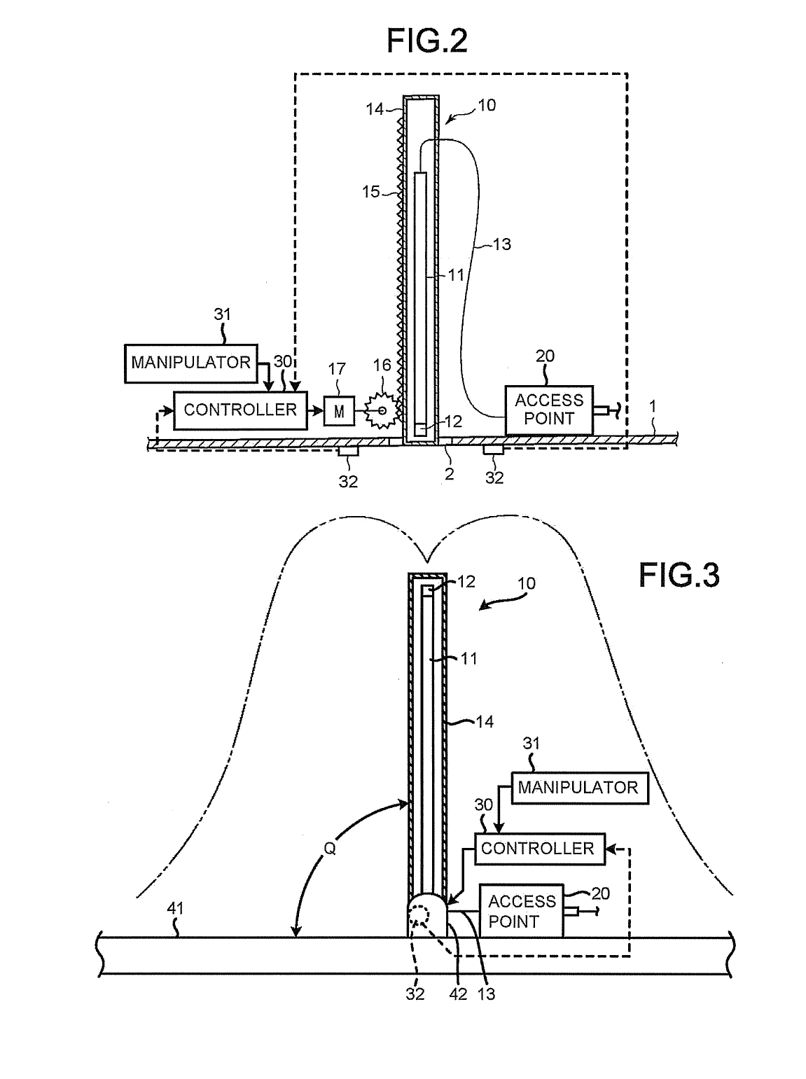

In a space between the roof and the ceiling surface 1 (referred to as a garret-space), the power supplying cable 13 extends out of the sheath 14 and is connected with an access point 20 serving as a power supplying means. In addition, a gear 16 is arranged at a position where the gear 16 can be meshed with the gear unit 15 of the antenna 10 and is connected with the rotation shaft of a motor 17. The gear unit 15 is pushed down by the gear 16 when the motor 17 rotates clockwise. Under this push-down action, the antenna 10 is lowered vertically to be protruded from the ceiling surface 1, as shown in FIG. 1. The gear unit 15 is pushed up by the gear 16 when the motor 17 rotates anticlockwise. Under this push-up action, the antenna 10 is lifted vertically to be housed into the garret-space, as shown in FIG. 2. The gear unit 15, the gear 16 and the motor 17 constitute a drive unit that moves the antenna 10 in the up and down direction, as described above.

A controller 30 is arranged in the garret-space and connected with the motor 17, a manipulator 31 and a plurality of human body sensors 32. Each of the human body sensors 32 is mounted around the opening 2 on the ceiling surface 1 with the detection surface thereof facing the ground to detect whether or not a person exists nearby the antenna 10 by capturing the infrared lay radiated from a human body. The purpose of arranging the manipulator 31 is to set the protruding position (protruding length D) of the antenna 10 through a manual operation.

The controller 30, which controls the protruding and housing of the antenna 10, moves the antenna 10 to the protruding position set by the manipulator 31 when a person is detected by one of the human body sensors 32, or houses the antenna 10 when no person is detected by the human body sensors 32.

The specific control process of the controller 30 is described with reference to the flow chart in FIG. 5.

As shown in FIG. 5, in a state in which the antenna 10 is housed in the garret-space (refer to FIG. 2), if a person is detected by one of the human body sensors 32 in the detection areas, the controller 30 determines existence of a person in a service area of the antenna (Act 101: Yes) and moves the antenna (Act 102). That is, the antenna 10 is vertically lowered from the ceiling surface 1 and protruded to the protruding position, i.e., protruding length D from the ceiling surface 1, set by the manipulator 31.

The leaky coaxial cable 11 of the protruded antenna 10 leaks electric wave. Due to the leakage of the electric wave, a wireless LAN area, that is, the so-called service area (also referred to as a free spot), which is represented by two dotted lines in FIG. 1, is formed around the antenna 10. Anyone in this service area can freely carry out a wireless communication using a wireless communication terminal.

By operating the manipulator 31, the protruding length D of the antenna 10 can be adjusted to change the dimension (diameter) of the service area. Certainly, apart from the dimension of the service area, height of a user, type and size of an advertisement image printed on the outer periphery of the sheath 14, height of the ceiling surface 1 and positions of an illuminator or lighting device and an air conditioner unit arranged on the ceiling surface 1 are also taken into consideration in the setting of the protruding length D.

The controller 30 determines absence of a person in the service area (Act 101: No) when the person leaves the detection areas of the human body sensors 32 and starts to count a time T (Act 103). Moreover, the controller 30 houses the antenna 10 (Act 105) if the time T during which no person exists in the service area reaches a prescribed time T1 (Act 101: No, Act 103: Yes, Act 104: Yes) and clears the time T (Act 106). That is, the antenna 10 is lifted from the ceiling surface 1 to be housed in the garret-space. The housed antenna 10 will not be an obstruction to the moving people.

As stated above, compared with a leaky coaxial cable that is only laid along the ceiling surface 1, the leaky coaxial cable 11 which is used as a tower-shaped antenna 10 that can be protruded and housed freely is more convenient to use.

That is, the antenna 10 is in a protruding state while the wireless LAN area is working or in effect and in an housed state while the wireless LAN area is not working, thus, a user can visually recognize whether or not the wireless LAN area is working immediately by observing the antenna 10. Additionally, it can save the power and achieve an energy-saving effect compared with the case that the working of the wireless LAN area is informed by turning on a lamp or light-emitting diode.

Since the protruding length D of the antenna 10 is adjustable, intensity of the leaked electric wave, heights and number of the users, type and size of an advertisement image printed on the sheath 14, height of the ceiling surface 1, position of a lighting device and position of an air conditioner unit can be all taken into consideration to provide an optimal applicable service area of the antenna.

Further, the antenna 10 is completely housed in the garret-space in this embodiment. However, the lower end of the antenna 10 may be slightly exposed out of the ceiling surface 1 in the housed state. In this case, the exposed part becomes an index indicative of the position of the service area. The length of the exposed part can also be changed by the manipulator 31.

The following control process may also be added: it is determined, if a person entering the detection area of the human body sensor 32 stays in the detection area for a given time (e.g. a couple of seconds), that a user comes, and then the antenna 10 is protruded. This control process prevents unnecessary protrusion of the antenna 10 that is caused by a person passing through the detection area of a human body sensor 32.

The antenna 10 may also be installed on a floor surface or a table surface, but not limited to be installed on the ceiling surface 1. When installed on the floor surface or the table surface, the antenna 10 is lifted to be protruded from the floor surface or the table surface and lowered to be housed in the floor surface or the table surface.

A control function for determining whether or not a person detected by the human body sensor 32 is an ordinary user or staff (also referred to as host) may also be added. In this case, the antenna 10 is protruded if there is at least one ordinary user and housed if there is only staff. This control function can prevent unnecessary protrusion of the antenna 10 if the staff is carrying out a cleaning operation.

The drive unit may be another mechanism, but not limited to be composed of the gear unit 15, the gear 16 and the motor 17.

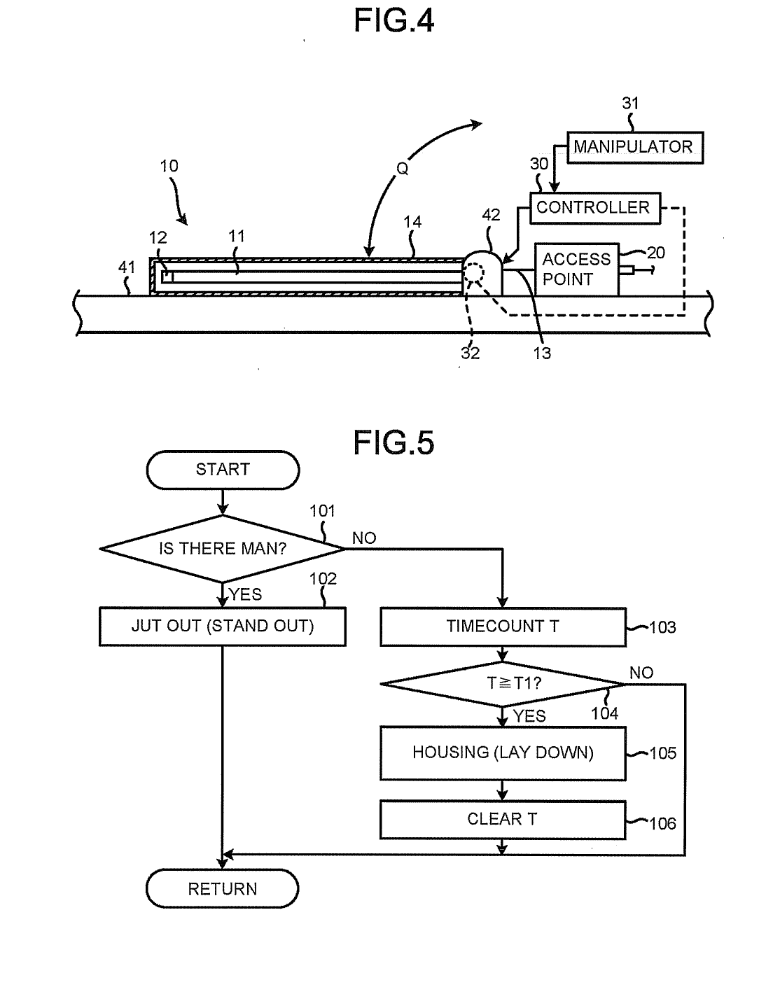

A second embodiment is described below with reference to the accompanying drawings (FIGS. 3 and 4). However, the same numerals are applied to the similar elements in the drawings, and therefore, the detailed descriptions thereof are not repeated.

As shown in FIG. 3, a rotation mechanism 42 is arranged, as a drive unit, on the upper surface (installed surface) of a table 41, and the lower portion of the antenna 10 is rotationally supported on the rotation mechanism 42. The rotation mechanism 42 comprises a motor and a gear. The antenna 10 is rotated freely at any position within the range of an angle Q defined by a first state that the antenna 10 is erected shown in FIG. 3 and a second state that the antenna 10 is laid shown in FIG. 4. At least one human body sensor 32 is arranged in the housing of the rotation mechanism 42.

The controller 30 sets the antenna 10 to be in a protruding state that the antenna 10 is erected to a protruding position (preset angle Q) set by the manipulator 31 when a person is detected by the human body sensor 32 and to be in a housed state that the antenna 10 is laid down when no person is detected by the human body sensor 32.

Like in the first embodiment, the specific control process carried out by the controller 30 is described with reference to the flow chart in FIG. 5.

As shown in FIG. 5, in a state in which the antenna 10 is laid down on the upper surface (referred to as table surface) of the table 41, i.e., a housed state (refer to FIG. 4), if a person enters the detection area of a human body sensor 32, the controller 30 determines the existence of the person in the service area (Act 101: Yes) and raises the antenna vertically (Act 102). That is, the antenna 10 rotates such that the upper portion thereof moves in the direction away from the table surface until it is erected to the angle Q preset by the manipulator 31.

The leaky coaxial cable 11 of the erected antenna 10 leaks electric wave. Due to the leakage of the electric wave, a wireless LAN area, that is, the so-called service area (also referred to as a free spot), which is represented by two dotted lines, is formed around the antenna 10 (refer to FIG. 3). Anyone in this service area can freely carry out a wireless communication using a wireless communication terminal.

The location of the service area can be changed by adjusting the angle Q of the antenna 10 through the operation of the manipulator 31. Certainly, in addition to the orientation of the service area, uses of the table, such as, e.g., studying, working, eating and drinking, position where the user stands and is seated, type and size of an advertisement image printed on the outer periphery of the sheath 14 and heights, areas and shapes of the table 41 should also be taken into consideration in the setting of the angle Q.

The controller 30 determines absence of a person in the service area (Act 101: No) when the person leaves the detection area of the human body sensors 32 and starts to count time T (Act 103). Moreover, the controller 30 houses the antenna 10 (Act 105) if the time T during which no person exists in the service area reaches T1 (Act 101: No, Act 103: Yes, Act 104: Yes) and clears the time T (Act 106). That is, the antenna 10 rotates such that the upper portion thereof rotates in the direction to the table 41 to be laid down on the table 41, thereby changing the antenna 10 into the housed state. The antenna 10 housed in this way will not be an obstruction.

As stated above, compared with a leaky coaxial cable that is only laid along the table surface, the leaky coaxial cable 11 which is used as a tower-shaped antenna 10 that can be erected and laid down freely is more convenient to use.

That is, the antenna 10 is raised when the wireless LAN area is working or in effect and laid down when the wireless LAN area is not working, thus, the user can recognize visually whether or not the wireless LAN area is working. Additionally, it can save the power and achieve an energy-saving effect compared with the case that the working of the wireless LAN area is informed by turning on a lamp or light-emitting diode.

Since degree of erecting the antenna 10 is adjustable in the range of the angle Q, intensity of the leaked electric wave, heights and number of the users, position of an advertisement image printed on the sheath 14 and height, area and shape of the table can be all taken into consideration to provide an optimal applicable service area.

The following control process may also be added: it is determined, if a person entering the detection area of a human body sensor 32 stays in the detection area for a given time (e.g. a couple of seconds), that a user exists, and then the antenna 10 is set to be in an erected state (protruding state). A groove for accommodating the laid-down antenna 10 may also be formed on the table surface. In this case, the table surface is flat when the wireless LAN area is not working and can be therefore wholly and effectively used. The antenna 10 may also be installed on a floor surface or a ceiling surface, but not limited to be installed on the table surface.

A control function for determining whether or not a person detected by the human body sensor 32 is an ordinary user or staff (also referred to as host) may also be added. In this case, the antenna 10 is erected if there is at least one ordinary user and housed if there is only staff. This control function can prevent the unnecessary erection (protrusion) of the antenna 10 if the staff is carrying out a cleaning operation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions.

The accompanying claims and their equivalents are intended to cover such forms or modifications as would fall within the scope and spirit of the inventions.

What is claimed is:

1. A wireless communication system, comprising:
a tower-shaped antenna having a service area, the tower-shaped antenna, including a leaky coaxial cable that leaks electric wave, which is changed from a protruding state in which the antenna is protruded from an installed surface to a housed state in which the antenna is housed in the installed surface, and vice versa.

2. The system according to claim 1, further comprising:
a controller configured to control the protruding and housing of the antenna.

3. The system according to claim 1, further comprising:
a human body sensor configured to detect whether or not a person exists within the service area of the antenna, wherein
the controller makes the antenna in the protruding state if the human body r sensor detects a person and makes the antenna in the housed state if the human body sensor does not detect a person.

4. The system according to claim 3, further comprising:
a manipulator configured to set the protruding position of the antenna; wherein
the controller protrudes the antenna to the protruding position set by the manipulator if the human body sensor detects a person and houses the antenna if the human body sensor does not detect a person.

5. The system according to claim 1, wherein
the antenna moves vertically through the installed surface so as to be in the protruding state and moves vertically towards the installed surface so as to be in the housed state.

6. The system according to claim 1, wherein
the antenna is raised up from the installed surface so as to be in the protruding state and laid down on the installed surface so as to be in the housed state.
